(19) United States
(12) Patent Application Publication
(10) Pub. No.: US 2020/0403484 A1
(43) Pub. Date: Dec. 24, 2020

(54) POWER SUPPLY APPARATUS FOR SUBMODULE CONTROLLER OF MMC

(71) Applicant: HYOSUNG HEAVY INDUSTRIES CORPORATION, Seoul (KR)

(72) Inventors: Yong Hee PARK, Anyang-si Gyeonggi-do (KR); Hong Ju JUNG, Seoul (KR); Jae Keun NO, Seoul (KR); In Soo WANG, Seoul (KR); Doo Young LEE, Anyang-si Gyeonggi-do (KR); Jong Kyou JEONG, Gunpo-si Gyeonggi-do (KR); Joo Yeon LEE, Seoul (KR)

(21) Appl. No.: 16/957,296

(22) PCT Filed: Dec. 21, 2018
(86) PCT No.: PCT/KR2018/016410

§ 371 Date: Jun. 23, 2020

(30) Foreign Application Priority Data
Dec. 28, 2017 (KR) 10-2017-0183195

(51) Int. Cl. H02K 7/18; F03B 13/00; H02K 9/19; H02K 11/00; H02K 11/04

(52) U.S. Cl. CPC H02K 7/1823; F03B 13/00; H02K 11/046; H02K 11/0094; H02K 9/19

(57) ABSTRACT

Proposed is a power supply device for a submodule controller of a modular multilevel converter (MMC) connected to a high voltage direct current (HVDC) system, which generates and supplies power through by hydraulic turbine generation using coolant flowing through a heat sink that cools a submodule. The power supply device includes a heat sink disposed inside the submodule of the MMC converter to cool the submodule using coolant; a pipe having an inlet configured to supply the coolant to the heat sink and an outlet configured to discharge the coolant to outside of the heat sink and configured to form a flow path to cause the coolant supplied through the inlet to flow to the heat sink; and a hydraulic turbine generator disposed at one side of the pipe to generate power by the coolant flowing through the pipe and supply the power to the submodule controller.

### TECHNICAL FIELD

The present invention relates to a power supply device for a submodule controller of an MMC converter, and in particular, a device for generating and supplying power through hydraulic turbine generation by using coolant flowing through a heat sink for cooling a submodule of a modular multilevel converter (MMC).

### BACKGROUND ART

Generally, in a High-Voltage Direct Current (HVDC) system, AC power, produced in a power plant, is converted into DC power and then transmitted, and the transmitted DC power is converted into AC power and then supplied to a load at a power reception side. The HVDC system may transmit power effectively and economically by voltage boosting, and is advantageous in interconnection between asynchronous grids and efficient power transmission over long distances.

In the HVDC system, a Modular Multilevel Converter (MMC) (hereinafter, referred to as an MMC converter) is used for power transmission and compensation for reactive power. Such an MMC converter includes multiple submodules, which are connected in series with each other. The submodules are very important components in the MMC and controlled by a controller separately provided, and a power supply device that converts a high voltage of the submodule to a low voltage necessary for the submodule controller is required to use a high voltage of the submodule as a driving power of the submodule controller,

In a conventional power supply system for a submodule controller of an MMC converter, a submodule provided in each phase of the MMC converter converts a stored high voltage into a low voltage using a DC/DC converter and supplies the converted voltage to the submodule controller as power.

However, in this case, the DC/DC converter cannot supply power to the submodule controller since the submodule is also not driven until the MMC converter is driven.

Therefore, there is a drawback that it is impossible to inspect the operation of the submodule controller or to monitor the state of the submodule before the MMC converter is driven when it is desired to monitor the submodule controller or the submodule.

### DISCLOSURE

### Technical Problem

Accordingly, an object of the present invention is to provide a power supply device for a submodule controller of an MMC converter, which generates power through hydraulic turbine generation using coolant flowing through a heat sink for cooling a submodule of the MMC converter and supplies a driving power to the submodule controller regardless of whether the MMC converter is driven.

### Technical Solution

According to an embodiment of the present invention, a power supply device for a submodule controller of an MMC converter includes a heat sink disposed inside the submodule of the MMC converter to cool the submodule using coolant; a pipe having an inlet configured to supply the coolant to the heat sink and an outlet configured to discharge the coolant to outside of the heat sink and configured to form a flow path to cause the coolant supplied through the inlet to flow to the heat sink; and a hydraulic turbine generator disposed at one side of the pipe to generate power according to a hydraulic turbine generating method by the coolant flowing through the pipe and supply the power to the submodule controller.

In the present invention, the hydraulic turbine generator may include a hydraulic part having a plurality of rotating blades installed radially from a central shaft therein; and a power generating part configured to convert a rotational force of the central shaft into power.

In the present invention, the power generating part may be integrally provided on the central shaft of the hydraulic part to convert the rotational force generated on the central shaft into power and output the power when the rotating blades of the hydraulic part are rotated by the coolant.

In the present invention, the power generating part may be provided in a form of being mounted on an extension extending from the central shaft of the hydraulic part to receive and convert the rotational force generated on the central shaft into power and output the power when the rotating blades of the hydraulic part are rotated by the coolant.

In the present invention, the inlet and outlet of the pipe may be provided to extend to outside of the heat sink and the hydraulic turbine generator may be disposed in the inlet or the outlet extending to the outside of the heat sink.

In the present invention, the hydraulic turbine generator may be disposed in a section in which the pipe is formed in a straight line and be disposed such that a section provided with the rotating blades of the hydraulic turbine generator is replaced with a partial section of the pipe to cause the coolant to flow through the section provided with the rotating blades to rotate the rotating blades.

In the present invention, the hydraulic turbine generator may be disposed in a section in which the pipe is bent in a U-shape and be disposed such that a section provided with the rotating blades of the hydraulic turbine generator is replaced with the section in which the pipe is bent in the U-shape to cause the coolant to flow through the section provided with the rotating blades to rotate the rotating blades.

In the present invention, the hydraulic turbine generator may be disposed in a section in which the pipe is bent at 90 degrees and be disposed such that a section provided with the rotating blades of the hydraulic turbine generator is replaced with the section in which the pipe is bent at 90 degrees to cause the coolant to flow through the section provided with the rotating blades to rotate the rotating blades.

According to an embodiment of the present invention, a submodule controller power supply system for an MMC converter includes the power supply device for the submodule controller of the MMC converter; a bridge circuit unit including an energy storage unit configured to store a DC voltage and a plurality of power semiconductors connected in parallel to the energy storage unit in a bridge form, the energy storage unit and the plurality of power semiconductors being disposed in the submodule; a resistor unit including a first resistor and a second resistor connected to each other in series and connected in parallel to the energy storage unit; and a DC/DC converter configured to convert a voltage output from an output terminal formed at both ends of the second resistor of the resistor unit to a low voltage and supply power to the submodule controller of the MMC converter.

The submodule controller power supply system for an MMC converter according to an embodiment of the present invention may further include a switching unit configured to supply power generated by the hydraulic turbine generator of the heat sink when a voltage is not stored in the energy storage unit, and supply power output through the DC/DC converter to the submodule controller when a voltage is stored in the energy storage unit and a voltage across the both ends of the second resistor is greater than a predetermined voltage.

In the present invention, the bridge circuit unit may include one selected from a half-bridge circuit or a full-bridge circuit.

### Advantageous Effects

According to the present invention, since coolant flows through the heat sink for cooling the submodule regardless of whether or not the MMC converter is driven, power generated through hydraulic turbine generation using coolant can be supplied to the submodule controller of the MMC converter.

According to the power supply device for the submodule controller of the present invention, it is possible to examine the submodule even before the MMC converter is driven, and when the MMC converter is driven after the submodule has been examined, power is supplied to the submodule controller by using a high voltage stored in the submodule, thus achieving stable power supply and operation.

### DESCRIPTION OF DRAWINGS

FIG. 1 is a schematic configuration diagram of a power supply device for a submodule controller of an MMC converter according to an embodiment of the present invention.

FIG. 2 is a view showing an embodiment of a detailed shape of a hydraulic turbine generator according to an embodiment of the present invention.

FIG. 3 is a schematic configuration diagram of a submodule controller power supply system for an MMC converter according to an embodiment of the present invention.

FIG. 4 is a view showing an embodiment of an arrangement configuration of a hydraulic turbine generator according to an embodiment of the present invention.

### MODE FOR INVENTION OR BEST MODE

Hereinafter, some embodiments of the present invention will be described in detail with reference to the exemplary drawings. In adding reference numerals to the components of each drawing, it should be noted that the same reference numerals are assigned to the same components as much as possible even though they are shown in different drawings. In addition, in describing the embodiment of the present invention, if it is determined that the detailed description of the related known configuration or function interferes with the understanding of the embodiment of the present invention, the detailed description thereof will be omitted.

In addition, in describing the components of the embodiments of the present invention, terms such as first, second, A, B, (a), and (b) may be used. These terms are only for distinguishing the components from other components, and the nature and order, etc. of the components are not limited by the terms. If a component is described as being “connected”, “combined”, or “coupled” to another component, the component may be directly connected or combined with the another component, but it should be understood that still another component may be “connected”, “combined”, or “coupled” to each of the components therebetween.

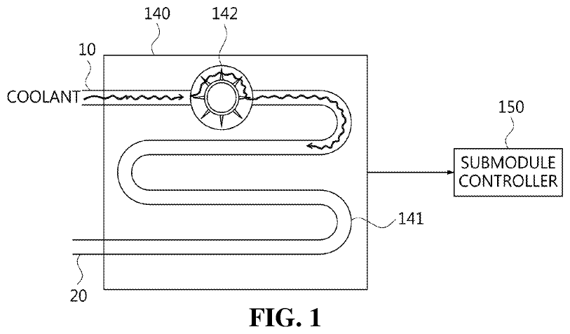

FIG. 1 is a schematic configuration diagram of a power supply device for a submodule controller of an MMC converter according to an embodiment of the present invention.

A power supply device 100 for a submodule controller of an MMC converter according to an embodiment of the present invention is applied to the MMC converter including one or more phase modules.

The phase module includes a plurality of submodules connected in series with one another, and DC voltage terminals of the phase module are connected to positive (+) and negative (−) DC voltage buses P and N, respectively. The plurality of submodules are connected in series to one another through two input terminals X and Y and store a DC voltage in an energy storage units connected in series to one another.

The operation of the submodule is controlled by a submodule controller 150, and the power supply device 100 for the submodule controller of the MMC converter according to the present invention includes a hydraulic turbine generator 142 in a heat sink 140 that cools the submodule and supplies power generated by the flow of coolant flowing through the pipe 141 as a driving power of the submodule controller 150.

Referring to FIG. 1, the power supply device 100 for the submodule controller of the MMC converter according to an embodiment of the present invention includes the heat sink 140, the pipe 141, the hydraulic turbine generator 142.

The heat sink 140 is disposed inside the submodule, and includes the pipe 141 having an inlet 10 and an outlet 20 therein to form a flow path of coolant, and the hydraulic turbine generator 142 that generates power through the flow of the coolant is provided at one side of the pipe 141 to supply power generated by the hydraulic turbine generator 142 as the driving power of the submodule controller 150.

It is preferable that a cooling system (not shown) that cools the submodule by supplying coolant to the heat sink 140 and a pump (not shown) that supplies coolant to the heat sink 140 are preferably provided outside the submodule. Since the cooling system and the pump are driven separately from the driving of the MMC converter, it is possible to supply the coolant to the heat sink 140 to cause the coolant to flow through the heat sink 140 independently even when the MMC converter has been not driven, so that the driving power of the sub-module controller 150 is generated and supplied by the coolant and the hydraulic turbine generator 142 in the heat sink 140 regardless of whether the MMC converter is driven.

The pipe 141 is configured to circulate the inside of the heat sink 140, and its shape may be formed differently according to embodiments.

The pipe 141 is provided with an inlet 10 through which the coolant supplied from a cooling system is introduced into the heat sink 140 and an outlet 20 through which the coolant is discharged back to the cooling system after circulating in the inside of the heat sink 140, and because the inlet 10 and the outlet 20 extend to the outside of the heat sink 140 because the inlet 10 and the outlet 20 are connected to the cooling system.

the hydraulic turbine generator 142 is provided at one side of the pipe 141 and it can be seen from FIG. 1 that the pipe 141 is disposed to be inserted at any point in a section of the straight line.

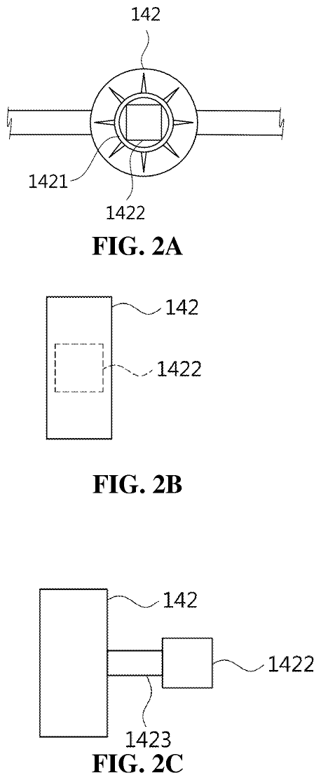

The hydraulic turbine generator 142 is provided with a plurality of rotating blades, and when the coolant flowing through the pipe 141 is introduced to flow, the plurality of rotating blades are rotated by the coolant, and an embodiment for the detailed shape of the hydraulic turbine generator 142 are shown in FIG. 2.

Referring to (a) of FIG. 2, it can be seen that the hydraulic turbine generator 142 includes a hydraulic part 1421 formed in a circle shape and having plurality of rotating blades which are radially installed from the central shaft therein, and a power generating part 1422 that converts a rotational force generated at a central shaft to power and, when the coolant flowing through the pipe 141 is introduced to flow in a section in which the rotating blades of the hydraulic turbine generator 142 are installed, a number of rotating blades are rotated by the coolant.

The rotational force generated when the rotating blades of the hydraulic part 1421 are rotated is transferred to the power generating part 1422 including an electric motor at the central shaft. In the embodiment shown in (b) of FIG. 2, the power generating part 1422 is provided integrally with the central shaft of the hydraulic turbine generator 142 to immediately convert the rotational force generated at the central shaft to power and transfer the generated power to the submodule controller 150 through a power line or the like.

However, in a case where the power generating part 1422 is integrally formed on the central shaft of the hydraulic turbine generator 142, when action is to be taken because an abnormality occurs in the power generating part 1422, the entire hydraulic turbine generator 142 must be removed, leading to occurrence of difficulties in maintenance.

Therefore, for the convenience of maintenance of failure inspection, the power generating part 1422 may be separately provided outside of the hydraulic turbine generator 142. Referring to (c) of FIG. 2, the power generating part 1422 is mounted on an extension part 1423 extending from the central shaft of the hydraulic turbine generator 142. When the abnormality occurs in the power generating part 1422, the hydraulic part 1421 of the hydraulic turbine generator 142 is left as it is, and the extension part 1423 is separated from the central shaft, or the power generating part 1422 is separated from the extension part 1423 so that only the power generating part 1422 can be subjected to maintenance separately.

In this case, when the rotating blades of the hydraulic part 1421 are rotated, the extension part 1423 mounted to the central shaft of the hydraulic turbine generator 142 is also rotated, and the power generating part 1422 mounted on the extension part 1423 is also rotated. The rotational force by the rotating blades is transferred to the power generating part 1422, and the power generating part 1422 converts the rotational force into power and supplies the power to the submodule controller 150.

That is, the power supply device 100 for the submodule controller of the MMC converter according to an embodiment of the present invention shown in FIG. 1 includes the hydraulic turbine generator 142 in a partial section of the pipe 141 inside the heat sink 140. When the coolant flows through the pipe 141 of the heat sink 140, the power is generated by the rotational force produced by rotation of the rotational blades inside the hydraulic turbine generator 142 due to the coolant and supplied to the submodule controller 150.

A submodule controller power supply system 1000 for the MMC converter including the power supply device 100 for the submodule controller of the MMC converter will be described in detail.

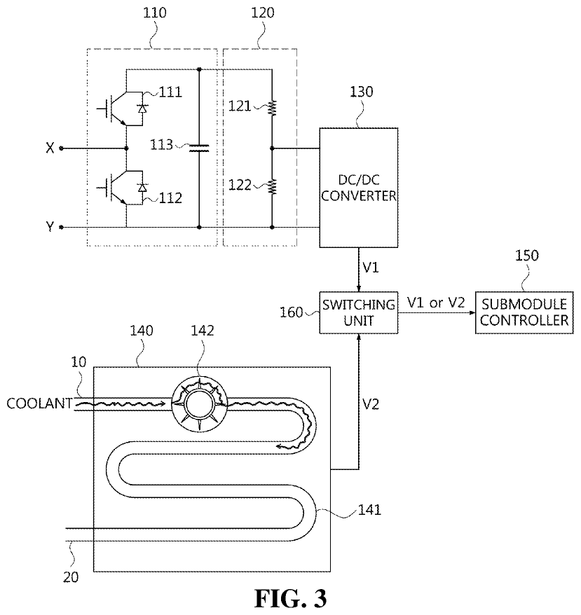

FIG. 3 is a schematic configuration diagram of a submodule controller power supply system for an MMC converter according to an embodiment of the present invention.

Referring to FIG. 3, a submodule controller power supply system 1000 of for an MMC converter according to an embodiment of the present invention includes a bridge circuit unit 110, a resistor unit 120, a DC/DC converter 130, a heat sink 140 and a switching unit 160.

The bridge circuit unit 110 includes an energy storage unit 113 and a plurality of power semiconductors 111 and 112, and the energy storage unit 113 stores a DC voltage.

The plurality of power semiconductors 111 and 112 are connected in parallel to the energy storage unit 113 in the form of a bridge. In this embodiment, the bridge circuit unit 110 may include a half bridge circuit or a full bridge circuit.

In addition, the energy storage unit 113 is a device that stores a DC voltage, and may be implemented with, for example, a capacitor, and the power semiconductors 111 and 112 are devices that switch the flow of a current, and may be implemented with, for example, IGBTs, FETs, or transistors.

FIG. 3 shows an example in which the energy storage unit 113 and the plurality of power semiconductors 111 and 112 constitute a half bridge circuit.

Specifically, in the example of the bridge circuit unit 110 illustrated in FIG. 3, two power semiconductors 111 and 112 connected in series with each other are connected in parallel to the energy storage unit 113 to form a half bridge circuit.

The power semiconductors 111 and 112 include a turn-on/turn-off controllable power semiconductor switch and a reflux diode connected in parallel thereto.

The power semiconductors 111 and 112 are turned on/off by a control signal from the submodule controller 150.

In addition, a first input terminal X and a second input terminal Y are formed at both ends of one of the power semiconductors of the two power semiconductors 111 and 112 of the bridge circuit unit 110 and connected in series to other submodules. As an example in the drawing, the two power semiconductors 111 and 112 are illustrated as an example, but the present invention is not limited thereto.

The energy storage unit 113 of the bridge circuit unit 110 is connected in parallel to the resistor unit 120 consisting of a first resistor 121 and a second resistor 122.

The first resistor 121 and the second resistor 122 are connected in series with each other, and both ends of the second resistor 122 are connected to the DC/DC converter 130.

That is, the DC voltage stored in the energy storage unit 113 is divided by the first resistor 121 and the second resistor 122 by the above-described connection relationship, and the DC voltage formed in the second resistor 122 due to voltage division is input to the DC/DC converter 130 and converted to an appropriate low voltage as the driving voltage of the submodule controller 150.

The DC/DC converter 130 converts a high voltage stored in the energy storage unit 113 of the submodule of the MMC converter to a low voltage and supplies the low voltage as the driving power of the submodule controller 150. When the MMC converter is not driven, the voltage is not stored in the energy storage unit 113 of the submodule and the DC/DC converter 130 cannot supply a driving power to the submodule controller 150.

When the user wants to monitor the state of the submodule using the submodule controller 150 before driving the MMC converter or to monitor the self-state of the submodule controller 150, the driving power is not supplied to the submodule controller 150 before the MMC converter is driven, thus making inspection impossible.

Before the driving of the MMC converter, a separate power supply device is required to inspect the state of the submodule controller 150 and the submodule, and in the present invention, the separate power supply device is provided in the heat sink 140 installed to cool the submodule. The separate supply device is a device that supplies power power generated through the pipe 141 and the hydraulic turbine generator 142 provided inside the heat sink 140 shown in FIG. 1.

The power generated through the hydraulic turbine generator 142 provided in the heat sink 140 is supplied to the submodule controller 150. One of the power generated in the heat sink 140 and the power converted by the DC/DC converter 130 may be supplied to the submodule controller 150.

That is, when the MMC converter is not driven, the power generated in the heat sink 140 should be supplied to the submodule controller 150, and when the MMC converter is driven after the inspection of the submodule and the submodule controller 150 is completed using the power, the power converted through the DC/DC converter 130 should be supplied to the submodule controller 150.

Therefore, a switching device for supplying one of the two powers to the submodule controller 150 is required, which is the switching unit 160 shown in FIG. 3.

When a voltage is not supplied from the DC/DC converter 130 because the voltage is not stored in the energy storage unit 113, the switching unit 160 supplies a voltage V2 generated through the hydraulic turbine generator 142 of the heat sink 140 to the submodule controller 150, and the voltage is stored in the energy storage unit 113, and when a voltage formed at both ends of the second resistor 122 becomes equal to or greater than a predetermined voltage, supplies the voltage V1 output from the DC/DC converter 130 to the submodule controller 150.

In this case, the predetermined voltage is preferably set to be in a range of voltage in which the voltage formed at both ends of the second resistor 122 satisfies a range of input voltage of the DC/DC converter 130 and a predetermined voltage required by the submodule controller 150 is able to be output.

The switching unit 160 is preferably implemented with a power switching device to supply one of the voltages V1 and V2 to the submodule controller 150, and is more preferably implemented with a power switching device having a capacity satisfying a range of power required by the submodule controller 150.

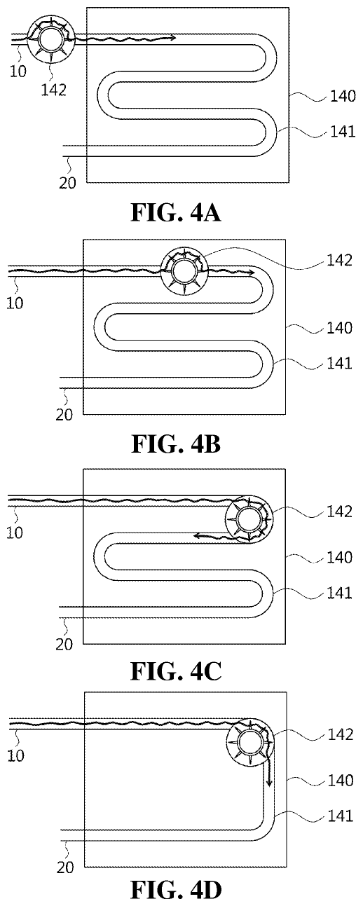

In the configuration of the submodule controller power supply system 1000 for the MMC converter of FIG. 3, the hydraulic turbine generator 142 may be disposed at various points on the pipe 141 of the heat sink 140. An embodiment according to the arrangement configuration of the hydraulic turbine generator 142 will be described in more detail with reference to FIG. 4.

FIG. 4 shows four embodiments (a) to (d) for the arrangement configuration of the hydraulic turbine generator 142 in the heat sink 140.

Referring first to (a) of FIG. 4, the pipe 141 provided in the heat sink 140 has the inlet 10 and the outlet 20, and the hydraulic turbine generator 142 is provided on the inlet 10 extending to the outside of the heat sink 140.

Although the hydraulic turbine generator 142 is illustrated as being disposed at the inlet 10 in (a) of FIG. 4, the hydraulic turbine generator 142 may be disposed not only at the inlet 10 but also at the outlet 20.

In this case, the hydraulic turbine generator 142 is disposed in the outside of the heat sink 140 not in the inside thereof and is therefore advantageous for inspection or state monitoring, but additional space may be required to install the hydraulic turbine generator 142 outside the heat sink 140.

In (b) of FIG. 4, it is illustrated that the hydraulic turbine generator 142 is disposed in a section in which the pipe 141 is formed in a straight line among the sections of the pipe 141 formed inside the heat sink 140 in the same form as that shown in FIG. 1.

In this case, the coolant that flows through the straight section of the pipe 141 flows through a section provided with the rotating blades formed in a curve in a section where the hydraulic turbine generator 142 is installed, and then flows again through the straight section of the pipe 141.

In this case, when the coolant flows through the inside of the hydraulic turbine generator 142, a section through which the coolant flows from bottom to top is included, so that a rotational force may be generated through the rotating blades only when it has a flow rate and a flow amount which are sufficient to rotate the rotating blades.

Therefore, the arrangement configuration to compensate for these disadvantages is shown in (c) and (d) of FIG. 4.

It can be seen from (c) of FIG. 4 that the hydraulic turbine generator 142 is disposed at a section in which the pipe 141 is bent in a U-shape. In this case, a portion of a rotating blade section through which coolant flows is designed and disposed to have a width in such a manner that the portion is replaced with the U-shaped bent section of the pipe 141 and therefore, the coolant flows naturally along the curved section bent from top to bottom. In this case, the coolant flows through the rotating blade section of the hydraulic turbine generator 142 in the same flow as that in a state where the hydraulic turbine generator 142 is not provided, thereby increasing the effect of generating the rotational force.

Also, referring to (d) of FIG. 4, when the pipe 141 is bent at 90 degrees within the heat sink 140, the hydraulic turbine generator 142 is disposed such that the section in which the rotating blades are disposed is replaced with the section of the pipe 141 that is bent at 90 degrees, so that the coolant flows in the same manner as that in a state where the hydraulic turbine generator 142 is not provided, thereby increasing the effect of generating the rotational force due to flow of the coolant, like (c) of FIG. 4,

It is possible to supply power generated by hydraulic turbine generation using coolant flowing through the heat sink 140 to the submodule controller 150 through the submodule controller power supply system 1000 for the MMC converter in which the hydraulic turbine generator 142 is applied to the heat sink 140, regardless of the driving of the MMC converter, thus enabling inspection of the submodule and submodule controller 150 before driving of the HVDC system. When the HVDC system is driven after the inspection is completed, it is possible to supply power to the submodule controller 150 using a high voltage stored in the submodule, thus enabling stable power supply and operation.

As described above, although the present invention has been described in detail with reference to preferred embodiments, it should be noted that the present invention is not limited to the description of these embodiments. It is apparent that those skilled in the art to which the present invention pertains can perform various changes or modifications of the present invention without departing from the scope of the accompanying claims and those changes or modifications belong to the technical scope of the present invention although they are not presented in detail in the embodiments. Accordingly, the technical scope of the present invention should be defined by the accompanying claims.

1. A power supply device for a submodule controller of an MMC converter, comprising:
a heat sink disposed inside the submodule of the MMC converter to cool the submodule using coolant;
a pipe having an inlet configured to supply the coolant to the heat sink and an outlet configured to discharge the coolant to outside of the heat sink and configured to form a flow path to cause the coolant supplied through the inlet to flow to the heat sink; and
a hydraulic turbine generator disposed at one side of the pipe to generate power according to a hydraulic turbine generating method by the coolant flowing through the pipe and supply the power to the submodule controller.

2. The power supply device of claim 1, wherein the hydraulic turbine generator includes
a hydraulic part having a plurality of rotating blades installed radially from a central shaft therein; and
a power generating part configured to convert a rotational force of the central shaft into power.

3. The power supply device of claim 2, wherein the power generating part is integrally provided on the central shaft of the hydraulic part to convert the rotational force generated on the central shaft into power and output the power when the rotating blades of the hydraulic part are rotated by the coolant.

4. The power supply device of claim 2, wherein the power generating part is provided in a form of being mounted on an extension extending from the central shaft of the hydraulic part to receive and convert the rotational force generated on the central shaft into power and output the power when the rotating blades of the hydraulic part are rotated by the coolant.

5. The power supply device of claim 2, wherein the inlet and outlet of the pipe are provided to extend to outside of the heat sink and the hydraulic turbine generator is disposed in the inlet or the outlet extending to the outside of the heat sink.

6. The power supply device of claim 2, wherein the hydraulic turbine generator is disposed in a section in which the pipe is formed in a straight line and is disposed such that a section provided with the rotating blades of the hydraulic turbine generator is replaced with a partial section of the pipe to cause the coolant to flow through the section provided with the rotating blades to rotate the rotating blades.

7. The power supply device of claim 2, wherein the hydraulic turbine generator is disposed in a section in which the pipe is bent in a U-shape and is disposed such that a section provided with the rotating blades of the hydraulic turbine generator is replaced with the section in which the pipe is bent in the U-shape to cause the coolant to flow through the section provided with the rotating blades to rotate the rotating blades.

8. The power supply device of claim 2, wherein the hydraulic turbine generator is disposed in a section in which the pipe is bent at 90 degrees and is disposed such that a section provided with the rotating blades of the hydraulic turbine generator is replaced with the section in which the pipe is bent at 90 degrees to cause the coolant to flow through the section provided with the rotating blades to rotate the rotating blades.

9. A submodule controller power supply system for an MMC converter, comprising:
the power supply device for the submodule controller of the MMC converter according to claim 1;
a bridge circuit unit including an energy storage unit configured to store a DC voltage and a plurality of power semiconductors connected in parallel to the energy storage unit in a bridge form, the energy storage unit and the plurality of power semiconductors being disposed in the submodule;
a resistor unit including a first resistor and a second resistor connected to each other in series and connected in parallel to the energy storage unit; and
a DC/DC converter configured to convert a voltage output from an output terminal formed at both ends of the second resistor of the resistor unit to a low voltage and supply power to the submodule controller of the MMC converter.

10. The submodule controller power supply system of claim 9, further comprising: a switching unit configured to supply power generated by the hydraulic turbine generator of the heat sink when a voltage is not stored in the energy storage unit, and supply power output through the DC/DC converter to the submodule controller when a voltage is stored in the energy storage unit and a voltage across the both ends of the second resistor is greater than a predetermined voltage.

11. The submodule controller power supply system of claim 10, wherein the bridge circuit unit includes one selected from a half-bridge circuit or a full-bridge circuit.
